(19) United States
(12) Patent Application Publication
(10) Pub. No.: US 2025/0390117 A1
(43) Pub. Date: Dec. 25, 2025

(54) METHOD FOR PROVIDING REDUNDANT CONTROL OF AN AUTONOMOUS VEHICLE

(71) Applicant: Torc Robotics, Inc., Blacksburg, VA (US)

(72) Inventors: Dimitrios Tzempetzis, Stuttgart (DE); Andre Scholich, Leipzig (DE); Biswanath Behera, Stuttgart (DE); Bernd Reinhold, Stuttgart (DE)

(21) Appl. No.: 19/084,071

(22) Filed: Mar. 19, 2025

(30) Foreign Application Priority Data
Jun. 25, 2024 (DE) DE102024117869.8

(51) Int. Cl. G05D 1/87; G05D 1/223; G05D 1/65; G05D 109/10; G05D 111/30; H04W 4/40; H04W 4/80

(52) U.S. Cl. CPC G05D 1/87; G05D 1/223; G05D 1/65; H04W 4/40; H04W 4/80; G05D 2109/10; G05D 2111/30

(57) ABSTRACT

The present disclosure relates to a method for redundantly controlling an autonomously driving vehicle in an emergency situation in which the autonomously driving vehicle is stopped or moved to a hazard-free position by means of a remote control. In a method by means of which the autonomously driving vehicle can be controlled even if it cannot process incoming commands and signals, a steering and/or a brake and/or a motor of the autonomously driving vehicle is manually actuated wirelessly over a short distance via the activated remote control and a first actuator of the steering and/or a second actuator of the brake and/or a third actuator of the motor is controlled.

### CROSS-REFERENCE TO RELATED APPLICATIONS

The present application claims priority to German Patent Application No. 102024117869.8 filed on Jun. 25, 2024, and titled “METHOD FOR REDUNDANTLY CONTROLLING AN AUTONOMOUSLY DRIVING VEHICLE IN AN EMERGENCY SITUATION AND REMOTELY CONTROLLABLE AUTONOMOUSLY DRIVING VEHICLE”, which is hereby incorporated by reference in its entirety.

### TECHNICAL FIELD

The present disclosure relates to a method for redundantly controlling an autonomously driving vehicle in an emergency situation in which the autonomously driving vehicle is stopped or moved to a hazard-free position by means of a remote control, as well as to a vehicle with a remote control for redundantly controlling the driving operation.

### BACKGROUND

From U.S. Pat. No. 10,730,481 B2 a remote control for vehicle functionalities of a vehicle by means of a mobile terminal is known, in which selected vehicle functionalities are remotely triggered. The mobile device communicates wirelessly with vehicle components for their control or regulation via an interface, where data is sent from the device to the interface, which then receives and processes the same.

U.S. Pat. No. 11,370,391 B1 discloses a method for communicating with an autonomously driving vehicle, the vehicle functionalities of which are remotely controlled. In an emergency, a person is granted access to the autonomously driving vehicle and uses short-range communication to stop the vehicle or steer it to a safe area.

According to US 2021/0188345 A1, a method for communication of an autonomously driving vehicle is known, which can be controlled by a remote control with simple maneuvers.

The object of the present disclosure is to provide a method for redundantly controlling an autonomously driving vehicle in an emergency situation, by means of which the autonomously driving vehicle can be controlled even if it cannot process incoming commands and signals.

### BRIEF DESCRIPTION

In the method explained at the beginning for redundantly controlling an autonomously driving vehicle in an emergency situation in which the autonomously driving vehicle is stopped or moved to a hazard-free position by means of a remote control, a steering and/or a brake and/or a motor of the autonomously driving vehicle is manually actuated wirelessly over a short distance via the activated remote control and a first actuator of the steering and/or a second actuator of the brake and/or a third actuator of the motor are controlled. This ensures that even if an unexpected event occurs in which a self-driving vehicle cannot recognize or process commands and/or sensor signals from the vehicle systems and therefore cannot activate a safety mechanism, the vehicle is stopped at close range. The term “close range” should be understood to mean only a few meters. A person in possession of the remote control can be granted access to the vehicle in order to bring the vehicle to safety “manually” using the remote control.

Advantageously, a torque is applied to a steering wheel and/or a braking pressure is applied to the brakes by means of the remote control. The remote control thus enables a reduced number of driving maneuvers to be carried out in an emergency situation when safety protocols stored in the vehicle cannot be accessed.

In one embodiment, the autonomously driving vehicle is steered onto a shoulder using the remote control and stopped there. This largely prevents dangerous situations in road traffic.

In one variant, a maximum speed of the autonomously driving vehicle is set using the remote control by controlling the motor. Driving at a maximum speed of just a few kilometers per hour is supported by steering the vehicle using the remote control. For this purpose, the mechanical actuators of the virtual accelerator pedal can be designed in such a way that only a small speed range can be changed, which leads to a design-related limitation of the speed.

In one embodiment, wireless communication between the remote control and the first, second and third actuators occurs by bypassing a sensor system of the autonomously driving vehicle. This prevents any influence of sensor signals on the vehicle, which is then only subject to commands from the remote control.

It is advantageous if the maneuvers of the autonomous vehicle initiated manually by the remote control are carried out overriding commands from an external unit monitoring the autonomous vehicle. Such a monitoring unit is used to control the autonomously driving vehicle as well as to specify the routes to be taken and the cargo to be loaded or unloaded. However, since this unit is stationed far away from the autonomous vehicle, it is not possible to influence the driving behavior of the vehicle in an emergency, as it has no insight into the situation of the vehicle on site.

The present disclosure further relates to an autonomously driving vehicle with a remote control for redundant control of the driving operation, which is wirelessly coupled to vehicle actuators for determining driving maneuvers. In an autonomously driving vehicle, which can be controlled even if it cannot process incoming commands and signals, each vehicle actuator of the steering and/or the brake and/or the motor has a respective transceiver unit for receiving commands manually set on the remote control for setting the vehicle into emergency operation. Through the individual transceiver units, the respective decentralized control units of steering, brakes and motor are controlled directly by the remote control, bypassing a central vehicle control unit, so that reliable control of the aforementioned vehicle components can be ensured by the remote control.

In a further embodiment, the remote control has a joystick or a rotary push button for separately controlling the steering and/or the brake and/or the motor. This makes it possible to operate the steering, brakes and motor independently of one another using just one control element.

In another variant, the actuators of the steering and/or the brake and/or the motor act independently of a sensor system of the autonomously driving vehicle. This ensures that vehicle sensor signals do not influence the control of vehicle components in an emergency. Alternatively, a limited number of vehicle sensor signals may be permitted, particularly if they check minimum safety distances.

### BRIEF DESCRIPTION OF DRAWINGS

Further advantages, features and details will be apparent from the following description, in which at least one exemplary embodiment is described in detail, with reference to the drawings where appropriate. Described and/or illustrated features may form the subject matter of the present disclosure alone or in any meaningful combination, possibly also independently of the claims, and may in particular also be the subject matter of one or more separate applications. Same, similar and/or functionally identical parts are provided with the same reference numerals.

FIG. 1 shows an exemplary embodiment of the autonomously driving vehicle according to the present disclosure for carrying out the method according to the present disclosure.

### DETAILED DESCRIPTION

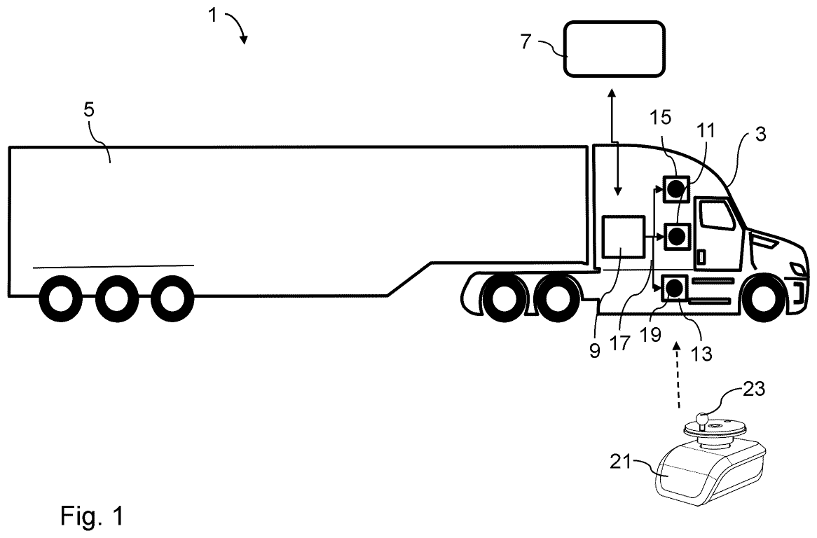

FIG. 1 shows an exemplary embodiment of the autonomously driving vehicle according to the present disclosure for carrying out the method according to the present disclosure. In the present case, the autonomously driving vehicle 1 is designed as a semi-trailer truck, which has a tractor 3 to which a semi-trailer 5 is coupled. Such autonomous commercial vehicles transport freight over long distances. The semi-trailers or trailers provided by a customer are uncoupled from an autonomous tractor in private, secure transshipment yards, so-called HUBs, and coupled to another autonomous tractor in order to reach the destination using an optimal route. The coordination of the autonomously driving commercial vehicles, their load, the semi-trailers or trailers and their maintenance and inspection take place within the private transshipment yard, which also controls the vehicle 1 during its journey via a vehicle-external mission monitoring unit 7.

In the self-driving vehicle 1, the vehicle maneuvers are controlled by a higher-level vehicle control unit 9, which is coupled to the vehicle components necessary for the operating behavior, such as the motor, brakes and steering. Each of these vehicle components comprises a decentralized control unit, such as motor control unit 11, brake control unit 13 and steering control unit 15, which communicates with the higher-level vehicle control unit 9 via a vehicle bus 17. At the same time, a transceiver unit 19 is positioned on each of the decentralized control units 11, 13, 15, which is designed to communicate with a remote control 21 over a short distance in an emergency situation, for example if the higher-level vehicle control unit 9 does not output any meaningful signals, in order to redundantly control an emergency driving maneuver of the autonomously driving vehicle 1. The remote control 21 comprises a joystick 23, which follows a simple menu navigation and allows the control of the steering, the brakes and the motor of the vehicle 1.

If an unexpected event occurs in the autonomously driving vehicle 1, as a result of which the higher-level control unit can no longer process the signals sent by sensors and cannot trigger a safety mechanism, an expert takes over control of the vehicle 1 by manually operating the activated remote control 21 from close range to the vehicle 1. In doing so, a torque is applied to the steering of the vehicle 1 via the joystick 23 and the brake is actuated. By means of this redundant system, simple driving maneuvers of the vehicle 1, which consist of a reduced number of driving functionalities, can be carried out in the special emergency mode, wherein the vehicle 1 is moved to a safe area of the road and brought to a standstill there, for example in order to clear an accident scene or to grant rescue workers access to other areas of the road. The safe area can be a shoulder. During this maneuver, the maximum speed of the vehicle 1 is limited to a few km/h.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A method for redundantly controlling an autonomous vehicle in an emergency situation in which the autonomous vehicle is stopped or moved to a hazard-free position, the autonomous vehicle comprising a vehicle component, and an actuator coupled thereto, the method comprising:
receiving a command from a remote control to the autonomous vehicle, and
activating the actuator to control the vehicle component in response to the received command,
wherein the vehicle component of the autonomous vehicle is manually acted upon wirelessly over a short distance via the activated remote control.

2. The method according to claim 1,
wherein the vehicle component is a steering wheel, and wherein a torque is applied to a steering wheel according to the command from the remote control.

3. The method according to claim 1,
wherein the vehicle component is a brake, and wherein a braking pressure is applied to the brake according to a command from the remote control.

4. The method according to claim 1,
wherein the vehicle component is a motor, and wherein the command is configured to set a maximum speed of the autonomous vehicle by controlling the motor.

5. The method according to claim 1,
wherein a wireless communication of the remote control with the actuator bypasses a sensor system of the autonomous vehicle.

6. The method according to claim 1,
wherein the maneuvers of the autonomous vehicle initiated manually by commands from the remote control override commands from an external unit configured to monitor the autonomous vehicle.

7. An autonomous vehicle with a redundant remote control for controlling the driving operation, which is wirelessly coupled to a vehicle actuator for determining driving maneuvers,
wherein the vehicle actuator is coupled to a vehicle component, the vehicle component comprises a respective transceiver unit configured to receive commands manually set on the remote control for setting an emergency driving mode of the vehicle.

8. (canceled)

9. An autonomous vehicle comprising a first actuator configured to actuate a steering system, a second actuator configured to actuate a braking system, and a third actuator configured to actuate a motor, wherein at least one of the first, second, or third actuator operates independently of a sensor system of the autonomous vehicle.

10. The method of claim 1, wherein the remote control comprises a joystick or a rotary push button for controlling the vehicle component.

11. The autonomous vehicle of claim 7, wherein the remote control comprises a joystick or a rotary push button for controlling the vehicle component.

12. The autonomous vehicle of claim 9, wherein the remote control comprises a joystick configured to provide control for the first actuator and a rotary push button configured to provide control of at least one of the second actuator and third actuator.

13. The method according to claim 2,
wherein the autonomous vehicle is stopped according to a command from the remote control in a safe area of the roadway.

14. The method according to claim 2,
wherein the remote control is configured to set a maximum speed of the autonomous vehicle by controlling the motor.

15. The method according to claim 1, wherein the vehicle component is a system of the vehicle selected from a group consisting of a steering wheel, a brake, and a motor.

16. The method according to claim 2,
wherein the maneuvers of the autonomous vehicle initiated manually by commands from the remote control override commands from an external unit configured to monitor the autonomous vehicle.

17. The method according to claim 3,
wherein the maneuvers of the autonomous vehicle initiated manually by commands from the remote control override commands from an external unit configured to monitor the autonomous vehicle.

18. The method according to claim 4,
wherein the maneuvers of the autonomous vehicle initiated manually by commands from the remote control override commands from an external unit configured to monitor the autonomous vehicle.

19. The method according to claim 5,
wherein the maneuvers of the autonomous vehicle initiated manually by commands from the remote control override commands from an external unit configured to monitor the autonomous vehicle.

20. The autonomous vehicle according to claim 7,
wherein at least one maneuver of the autonomous vehicle initiated manually by a command from the remote control overrides at least one commands from an external unit configured to monitor the autonomous vehicle.

21. The autonomous vehicle according to claim 9,
wherein at least one maneuver of the autonomous vehicle initiated manually by a command from the remote control overrides at least one commands from an external unit configured to monitor the autonomous vehicle.
